(19) United States
(12) Patent Application Publication
(10) Pub. No.: US 2017/0060235 A1
(43) Pub. Date: Mar. 2, 2017

(54) METHOD OF OPERATING A VEHICLE HEAD-UP DISPLAY

(71) Applicant: FORD GLOBAL TECHNOLOGIES, LLC, Dearborn, MI (US)

(72) Inventors: Matus BANYAY, Frechen (DE); Marcus HAEFNER, Cologne (DE)

(73) Assignee: FORD GLOBAL TECHNOLOGIES, LLC, Dearborn, MI (US)

(21) Appl. No.: 15/244,855

(22) Filed: Aug. 23, 2016

(30) Foreign Application Priority Data
Aug. 24, 2015 (DE) 10 2015 216 127.7

(51) Int. Cl. G06F 3/01; G02B 27/01; B60K 35/00; H04N 5/33

(52) U.S. Cl. CPC G06F 3/013; H04N 5/33; G02B 27/0179; G02B 27/0101; G02B 27/0149; B60K 35/00; G02B 2027/0138; G02B 2027/014; G02B 2027/0187; G02B 2027/0163; B60Y 2400/92

(57) ABSTRACT

The invention relates to a method for capturing fixations and viewing movements of the driver of a vehicle with a head-up display by way of observation using a camera (6) that receives an image of the head (2) of the driver which is reflected by a combiner (3) of the head-up display. According to the invention, at least some of the information displayed to the driver using the head-up display is selected depending on the fixations and viewing movements of the driver.

### CROSS-REFERENCE TO RELATED APPLICATIONS

This application claims foreign priority benefits under 35 U.S.C. §119(a)-(d) to DE 10 2015 216 127.7 filed Aug. 24, 2015, which is hereby incorporated by reference in its entirety.

### TECHNICAL FIELD

The invention relates to a method for capturing fixations and viewing movements of the driver of a vehicle with a head-up display by way of observation using a camera that receives an image of the head of the driver which is reflected by a combiner of the head-up display, and to a vehicle equipped therefor.

### BACKGROUND

Such a method, known as eye tracking, is known from US 2003/0142041 A1 and serves for identifying occurrences of lack of focus in the driver, without a camera in the cockpit limiting the driver's view.

Generally, there are two types of head-up displays in motor vehicles. One type uses the windshield as a combiner surface onto which a projection system, consisting of an image generator (also commonly referred to as a projector) and an image forming mirror, which can be shaped spherically, aspherically or freely, projects a virtual image that is visible to the driver. The other type utilizes a separate combiner surface, or simply “a combiner”, such as for example a transparent screen made of glass or plastic or a suitably configured prism, as the display surface. Such a combiner is typically located above the dashboard and close to the windshield, directly in front of the driver. The combiner can often be retracted into the dashboard or folded down parallel to the top surface of the dashboard when not in use. The combiner reflects the image generated by the image generator/projector in the direction of the driver.

The head-up display is used to display various elements of pertinent information to the driver, wherein the types of information displayed may be either preset or can be selected by the driver. The selection of the information is usually a compromise between the amount of detail provided to the driver and the speed and ease with which the information can be understood by the driver. The head-up display should not be overloaded with information, if for no other reason than this could negatively affect the driver's perception of the scene in front of the vehicle.

### SUMMARY

The invention utilizes a system of the type taught in US 2003/0142041 A1 in order to and track the direction in which a driver's eye or eyes is/are looking (the “gaze direction”) from an image of the head of the driver that is reflected by a combiner of the head-up display. The viewing limitations on and distractions to the driver caused by the head-up display can also be kept to a minimum by automatically only showing that information or additional information which appears to be relevant at the moment, based on the gaze direction of the driver, but not any other information that is irrelevant at the moment.

The automatic check as to what information could currently appear useful to the driver can be carried out in a manner known per se by comparing the gaze direction with the scene in front of the vehicle, which is synthesized from images of the cameras observing the scene, in particular front-mounted cameras which are operated independently of the head-up display, and from information from a navigation system and the Internet.

A check is made whether the driver is looking at an object or at a region within his field of view in respect of which information or additional information is available that is relevant to the driver, and in this case, the corresponding information is obtained and displayed using the head-up display, while information which does not appear relevant at the moment on the basis of the viewing direction of the driver is removed from the display.

For example, if the driver is looking at a vehicle in front, that vehicle's speed may be displayed; if the driver is looking in the direction of a gas station, the current price of gas that applies here may be shown; and if the driver is looking at a traffic sign or the like, current traffic messages may be displayed, for example, in the case of a sign on the highway, or how long a mandatory or prohibition restriction will be valid is shown in the case of a mandatory or prohibition sign. This information is automatically removed after a certain period of time when the driver no longer looks at the object.

The head-up display can be of the type having, as the combiner, a separate, translucent surface located in the light path between a windshield of the vehicle and the head of the driver, or of the type that uses the windshield as the combiner.

As is known from the above-mentioned document, the head of the driver can additionally be illuminated with light via the light path by which the driver sees the image displayed by the head-up display and also via which the eye tracking takes place, with said light having a wavelength in a range that is invisible to the human eye but visible to the camera, for example infrared light, so as to increase the contrast and reduce the red-eye effect, which facilitates eye tracking. In this case, said light path is used three times.

What follows is a description of an exemplary embodiment with reference to the drawing.

### BRIEF DESCRIPTION OF THE DRAWINGS

FIG. 1 is a partial longitudinal sectional view of a motor vehicle's head-up display having an image combination device, or combiner, above the dashboard.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

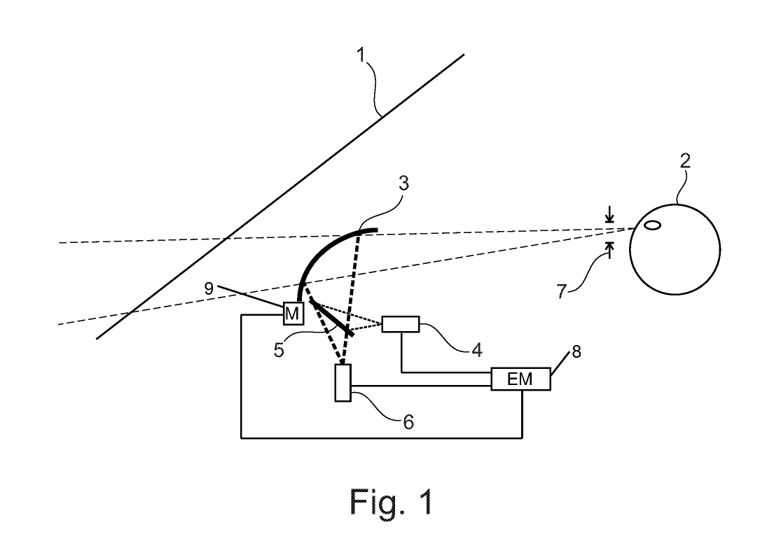

As shown in FIG. 1, a transparent projection screen or combiner 3, which can be retracted into the dashboard and moved out by way of an electric motor, is located in a motor vehicle having a head-up display (HUD) on top of the dashboard and relatively close to a windshield 1 and within the field of view of the driver, of whom only the head 2 is shown schematically.

The combiner 3 reflects an image that is projected onto it by a projector 4 (which generates and projects the light bundle to generate the image) via a beam splitter 5 in the direction of the driver's eyes, and combines said image with the part of the scene in front of the vehicle that is visible through the combiner 3, as indicated using dashed lines. The combiner 3 is pivotable within a small angular range about the vehicle transverse axis (normal to the plane of the paper on which FIG. 1 is printed) using an electric motor. Alternatively, the head-up display as a whole may be pivoted by a motor.

The image projected onto the combiner 3 and reflected thereby reaches the driver as a spatially-delimited light bundle, which defines what is known in the HUD art as an eyebox (also known as a head movement box), within which the information displayed by the head-up display is visible to the driver. The terms “light bundle” “eyebox” and “head movement box” are terms-of-art, the meanings of which are understood by persons of ordinary skill in the pertinent art.

A camera 6 is mounted below the combiner 3 (so as to not interfere with the driver's vision or clutter the interior of the vehicle) and receives the image, which is reflected in the combiner 3 and has passed through the beam splitter 5, of the head 2 of the driver, as indicated by way of dashed lines. A computer processor or electronic module (EM) 8 serves as an image evaluation device carries out simple eye tracking on the basis of the camera image in order to ascertain the position of the eyellipse (as defined in SAE Standard J941) and compare it to the current position of the eyebox generated by the HUD, wherein 7 indicates the upper and lower edges of the eyebox. If necessary, the combiner 3 is pivoted, thereby shifting the position of the eyebox so that the eyellipse is located approximately centrally within the eyebox.

In other words, the eyes of the driver are observed using the camera 6 which captures an image of the head 2 of the driver that is reflected in the combiner 3, wherein the position of the eyes of the driver is ascertained from the image of the head 2 of the driver seen by the camera 6 and wherein the direction of a light bundle coming from the combiner 3, within which the information displayed by the head-up display is visible to the driver, is matched automatically to the eye position thus ascertained by automatically pivoting the combiner 3 on the basis of the ascertained eye position such that the light bundle matches the ascertained eye position.

By automatically matching the height position of the eyebox, it is possible to make the eyebox smaller than is usually necessary, for example just 20 mm instead of 50 mm in height. This smaller eyebox can be generated with a smaller head-up display.

The camera 6 can be an infrared camera, and the head 2 of the driver can correspondingly be illuminated with infrared light (having a wavelength that is not visible to the driver) that is coupled into the common light path by way of a further beam splitter (not shown) and is reflected at the combiner 3.

In addition, the image evaluation device carries out real eye tracking on the basis of the camera image, in which the fixations and viewing movements of the driver are captured. The fixations and viewing movements are compared to the scene in front of the vehicle, which is synthesized from images by cameras observing the scene and from information from a navigation system and the Internet so as to select the information shown to the driver depending on the fixations and viewing movements of the driver.

What is examined in particular is whether the driver is looking at an object or a region within his field-of-view for which information or additional information is available that is relevant to the driver, and in this case, the corresponding information is obtained and displayed using the head-up display, while information that does not appear to be relevant at the moment on the basis of the viewing direction of the driver is removed from the display.

For example, if the driver is looking at the vehicle in front, that vehicle's speed is advantageously displayed; if the driver is looking in the direction of a gas station, the current gas price that applies here is advantageously displayed; and if the driver looks at a traffic sign or the like, current traffic messages are advantageously displayed. With regard to traffic signs, for example, in the case of a mandatory or prohibition sign, how long the mandatory or prohibition restriction will be valid may advantageously be displayed.

Expanded image evaluations can be carried out additionally, for example for facial recognition and driver assistance.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of operating a head-up display of a vehicle to selectively display information relevant to at least one of an object and a region outside the vehicle, comprising:
operating a camera located below a combiner of the head-up display to capture an image of a driver's head reflected by the combiner;
operating a processor to: a) determine a gaze-direction of at least one driver's eye from the image of the head captured by the camera; b) correlate the gaze direction with at least one of an object and a region outside the vehicle and aligned with the gaze direction; and c) identify information relevant to the at least one of the object and the region; and
displaying, on the head-up display, the relevant information.

2. The method of claim 1, further comprising illuminating the driver's head with light having a frequency/wavelength which is invisible to a human eye and is visible to the camera.

3. The method of claim 1, further comprising:
operating the processor to determine a position of the at least one driver's eye from the image of the head captured by the camera; and
automatically adjusting a position of the combiner to align an eyebox produced thereby with the position determined by the processor.

4. The method of claim 1, wherein the combiner comprises a translucent surface located in a light path between a windshield of the vehicle and the driver's head.

5. A method of operating a head-up display of a vehicle comprising:
operating a camera to capture an image of a driver's head reflected by a combiner of the head-up display;
operating a processor to: a) determine a gaze-direction of at least one driver's eye from the image of the head captured by the camera; b) correlate the gaze direction with at least one of an object and a region outside the vehicle and in the gaze direction; and c) select information relevant to the at least one of the object and the region; and
displaying, on the head-up display, the relevant information.

6. The method of claim 5, further comprising illuminating the driver's head with light having a frequency/wavelength which is invisible to a human eye and is visible to the camera.

7. The method of claim 5, further comprising:
operating the processor to determine a position of the at least one driver's eye from the image of the head captured by the camera; and
automatically adjusting a position of the combiner to align an eyebox produced thereby with the position determined by the processor.

8. The method of claim 5, wherein the combiner comprises a translucent surface located in a light path between a windshield of the vehicle and the driver's head.

9. A method of operating a head-up display of a vehicle comprising:
operating a camera to capture an image of a driver's head reflected by a combiner;
operating a processor to determine a gaze direction of an driver's eye from the image, correlate the gaze direction with an object and/or a region in the gaze direction, and select information relevant to the object; and
projecting onto the combiner information applicable to the object.

10. The method of claim 9, further comprising illuminating the driver's head with light having a frequency/wavelength which is invisible to a human eye and is visible to the camera.

11. The method of claim 9, further comprising:
operating the processor to determine a position of the at least one driver's eye from the image of the head captured by the camera; and
automatically adjusting a position of the combiner to align an eyebox produced thereby with the position determined by the processor.

12. The method of claim 9, wherein the combiner comprises a translucent surface located in a light path between a vehicle windshield and the driver's head.
